(19) United States
(12) Patent Application Publication
(10) Pub. No.: US 2016/0024895 A1
(43) Pub. Date: Jan. 28, 2016

(54) WELLBORE SCREEN, FILTER MEDIUM, AND METHOD

(71) Applicants: ABSOLUTE COMPLETION TECHNOLOGIES LTD., Calgary (CA); POROUS METAL FILTER INC., Longwood, FL (US)

(72) Inventors: Thane Geoffrey RUSSELL, Cochrane (CA); Rick KENNEY, Longwood, FL (US); Fred HARMAT, Edmonton (CA)

(21) Appl. No.: 14/436,863

(22) PCT Filed: Oct. 16, 2013
(86) PCT No.: PCT/CA2013/050785

§ 371 Date: Apr. 17, 2015

Related U.S. Application Data
(60) Provisional application No. 61/715,110, filed on Oct. 17, 2012.

(51) Int. Cl. E21B 43/08; B01D 35/02; B01D 29/11; B01D 39/12

(52) U.S. Cl. CPC E21B 43/084; B01D 39/12; B01D 35/02; B01D 29/111

(57) ABSTRACT

There is provided a wellbore screen having a base pipe and a strip of filter medium wrapped around the base pipe. The strip of filter medium includes one or more layers of woven steel mesh of various weave patterns, fibers sizes, and/or thread tensions. During the construction of the screen, the strip is wrapped around the base pipe under high tension. The strip has two lengthwise edges that may overlap to form a bonded interface.

### FIELD

The invention relates to a wellbore screen, a filter medium, and a method of constructing a wellbore screen.

### BACKGROUND

Various wellbore tubulars are known and serve various purposes. A wellbore screen is a tubular including a screen material forming or mounted in the tubular's wall. The wellbore screen can be used in wellbores such as those for water, steam injection and/or petroleum product production. The wellbore screen may be used to filter out sand and like particulate impurities from the produced fluid before the fluid is pumped to the surface. If some form of filter is not provided for fluid entering the well, sand and other impurities entrained in the fluid may materially reduce the effective life of the well pump and/or other apparatus to which the well is connected.

In one form, a wellbore screen is known that includes a wall of screen material held between end fittings. The wall includes screen material that may take various forms and is usually supported in some way, as by a perforated pipe. The outer surface of the screen material may or may not be protected by a perforated outer sleeve. These screens filter fluids passing through the screen material layer either into or out of the screen inner diameter. In general, the screen material is based on either two dimensional slots (also known as “wire wrap screen”) or two dimensional woven laminate (also known as “premium screens”). In general, premium screens have a single uniform weave pattern, which include a plain weave pattern as shown in FIG. 1 and other weave patterns such as “Dutch twill” and “double Dutch twill”. Conventional screens have uniform pore spaces that are essentially the same in spacing, shape, and size. As such, conventional screens do not provide variety and/or a statistical distribution of pore sizes therein.

In conventional screens, the screen material is sometimes made from a sheet of woven material that has been rolled into a cylinder with the seam welded together. Successive welded cylinders are sometimes slid over a perforated base pipe, welded together, and covered with a perforated shroud. Welded products require strict quality control to ensure the pore structure of the screen material is not damaged by the welding process, and that the welds themselves are of sufficient strength to withstand the significant forces encountered during deployment into long horizontal wells and during the heating and cooling cycles of steam-assisted gravity drainage (SAGD) and cyclic steam production.

### SUMMARY

In accordance with a broad aspect of the present invention, there is provided a filter medium comprising at least two layers of woven metal meshes that differ from one another in at least one of: weave pattern, weave direction, fiber size, and fiber tension.

In accordance with another broad aspect of the present invention, there is provided a wellbore screen comprising: an apertured base pipe; an intermediate filtering layer including a filter medium wrapped around the apertured base pipe, the filter medium comprising at least two layers of woven metal meshes, the at least two layers of woven metal meshes differ from one another in at least one of: weave pattern, weave direction, fiber size, and fiber tension; and an outer apertured shell over the intermediate layer.

In accordance with another broad aspect of the present invention, there is provided a wellbore screen comprising: an apertured base pipe; an outer apertured shell over the apertured base pipe; and filter cartridges comprising a filter medium, the filter cartridges being disposed in at least some of the apertures of one or both of the apertured base pipe and the outer apertured shell, the filter medium comprising at least two layers of woven metal meshes, the at least two layers of woven metal meshes differ from one another in at least one of: weave pattern, weave direction, fiber size, and fiber tension.

In accordance with another broad aspect of the present invention, there is provided a method for producing a wellbore screen, the method comprising: forming a filter tube by wrapping an intermediate layer, including a filter medium strip, about an apertured base pipe in a helical arrangement under tension, the filter medium strip comprising at least two layers of woven metal meshes, the at least two layers of woven metal meshes differ from one another in at least one of: weave pattern, weave direction, fiber size, and fiber tension; positioning the filter tube within the long bore of an outer apertured sleeve; and securing the outer apertured sleeve and the filter tube together.

### BRIEF DESCRIPTION OF THE DRAWINGS

Drawings are included for the purpose of illustrating certain aspects of the invention. Such drawings and the description thereof are intended to facilitate understanding and should not be considered limiting of the invention. Drawings are included, in which:

FIG. 1 is an elevation view of a plain weave pattern of a prior art screen material;

FIG. 2 is a simplified, partly diagrammatic plan view of an intermediate stage in one possible embodiment of the manufacturing method of the present invention;

FIG. 3 is a simplified elevation view of the apparatus of FIG. 2 with a part of that apparatus omitted to facilitate understanding;

FIG. 4 is a diagrammatic sectional elevation view taken approximately along line 4-4 in FIG. 2;

FIGS. 5a, 5b, and 5c are simplified cross-sectional views of illustrative embodiments of an interface of overlapping filter material of the wellbore screen;

FIG. 6a is a diagrammatic perspective view of a wellbore screen constructed in accordance with one embodiment of the invention with portions omitted to show the components of the screen;

FIG. 6b is a diagrammatic perspective view of a wellbore screen constructed in accordance with another embodiment of the invention with portions omitted to show the components of the screen;

FIG. 7 is a longitudinal sectional view of the wellbore screen of FIG. 6a; and

FIGS. 8a, 8b and 8c are simplified cross-sectional views of alternative embodiments of the wellbore screen.

### DETAILED DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

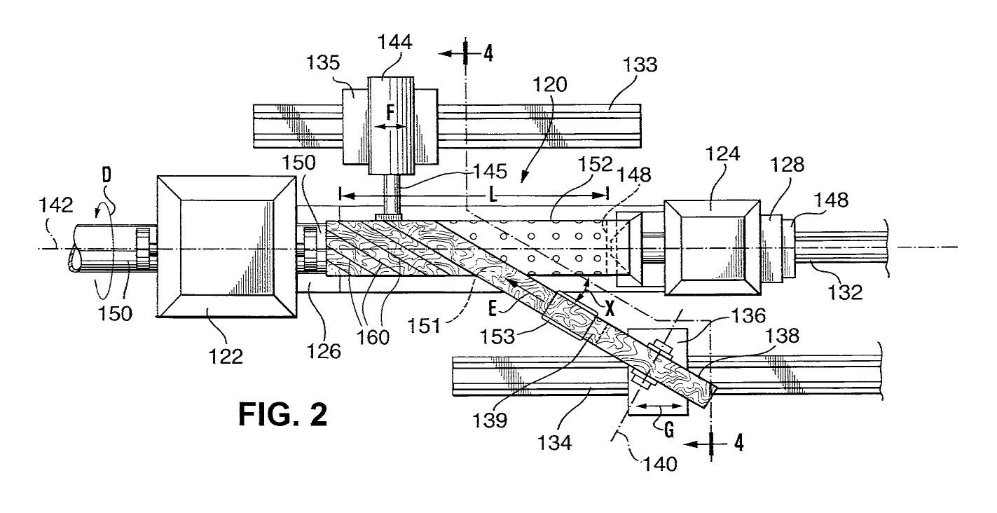

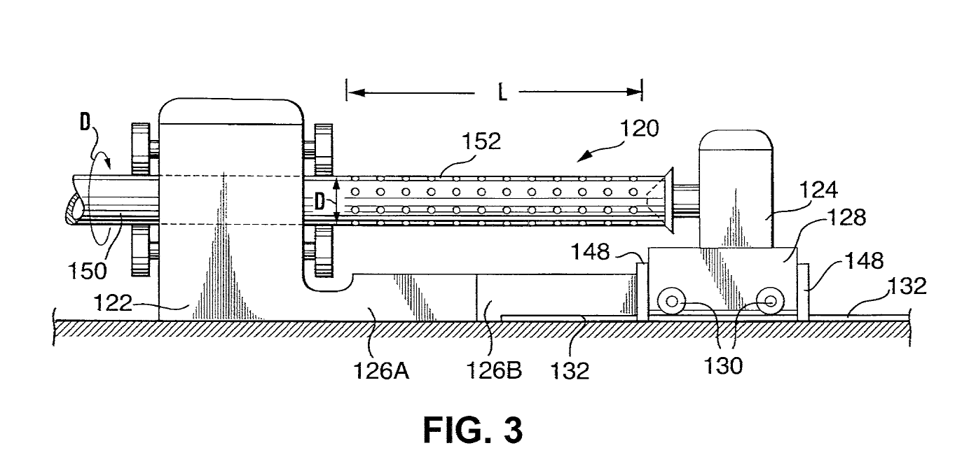

FIGS. 2 and 3 are simplified, schematic illustrations of one possible embodiment of an apparatus for manufacture of a wellbore screen suitable for use in the production tubing of a subterranean fluid well, pursuant to the present invention. The apparatus of FIGS. 2 and 3 comprises an engine lathe 120 including a head stock 122 spaced from a tail-stock 124 at opposite ends of a bed 126, FIG. 2. Lathe bed 126 may include sections 126A and 126B (see FIG. 3). The tail-stock 124 of lathe 120 may be mounted on a carriage 128 in turn supported by wheels 130 engaging a guide rail 132.

The illustrated apparatus further includes a guide rail 134 and optionally a guide rail 133 that are both parallel to but spaced from guide rail 132. There are also one or more carriages 135 and 136 that move along and are guided by rails 133 and 134, respectively. Carriage 136 supports a supply roll 138 of a strip 139 of metal filter medium 151; the metal filter medium is described more fully hereinafter. The axis 140 of roll 138 is aligned, on carriage 136, so that strip 139 is at an acute angle X relative to the axis 142 of lathe 120 and the surface onto which it is to be applied. The carriage 135 on rail 133 supports an interface treatment device 144 having a rod 145 that carries a treatment head that is further described hereinafter. Two stop members 148 may be provided to assure accurate positioning of tail stock carriage along rail 132.

The first step, in the method of the invention, is to provide a preselected length of the base pipe 150, which serves as the central support for the wellbore screen. Base pipe is selected eventually to be connectable into a longer pipe that is subsequently to serve as the production tubing for a subterranean well. Base pipe 150 is apertured along a section 152 thereof to permit fluid flow through the side wall of the pipe between its outer surface and its inner bore. Apertures may be in various forms and arrangements including perforations, channels, slots, underlay, nozzles, etc. For example, the apertures may allow for open, unrestricted fluid flow or controlled flow, for example as by use of ICD technology. In FIGS. 2 and 3, the apertured portion has a length L. Length L usually exceeds one foot (25.4 cm) but may be shorter. Generally, length L is always much greater than the outer diameter of the base pipe. At the outset, pipe 150 is mounted in lathe 120 with the apertured section 152 of the pipe positioned between head stock 122 and tail stock 124, as shown in FIGS. 2 and 3.

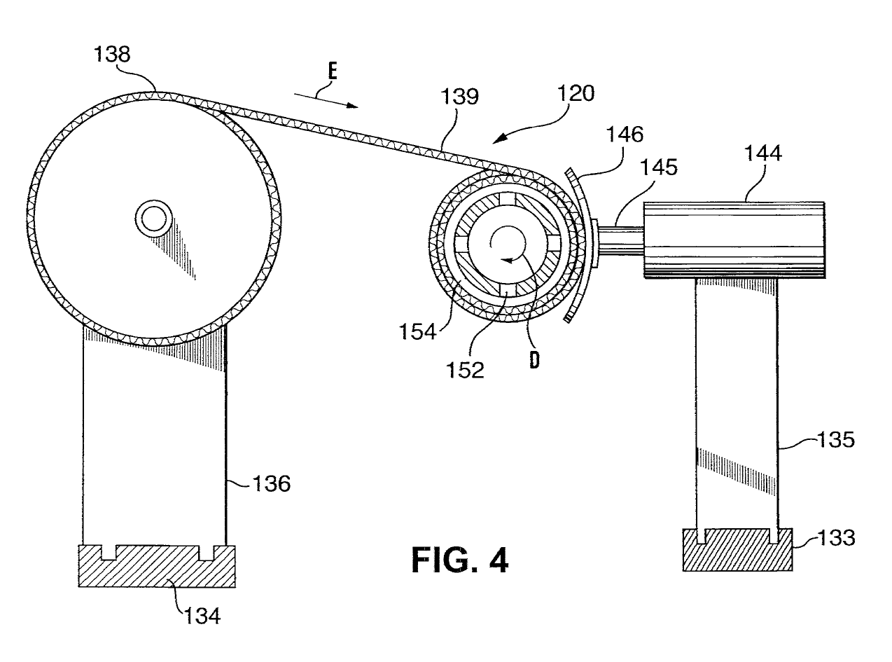

It may be desirable to optionally mount a single-layer tubular metal drainage member 154, not shown in FIGS. 2 and 3 but shown in FIG. 4, about at least the apertured portion 152 of the pipe between the head stock and tail stock of lathe 120. The metal drainage member 154 may be mounted on section 152 of the pipe before or after the pipe is mounted in lathe 120. The metal drainage member 154 may comprise of a porous material, such as for example open high offset mesh, thick wire weaves, coarse fiber compressed steel wools, etc.

The next step in the inventive method is to wrap a filter medium around section 152. In the illustrated embodiment, the filter medium comprises a plurality of metal fibers that are arranged in a form that can be handled as a strip 139 and that can withstand a pull tension. For example, in one embodiment the filter medium may be in the form of fusion bonded mesh laminate, for example in one embodiment, one or more layers of woven metal meshes. In a preferred embodiment, the filter medium comprises 1 to 12 layers of woven steel meshes of various fiber sizes and weave patterns. In a sample embodiment, the filter medium comprises 2 to 3 layers of woven steel meshes of various fiber sizes and weave patterns. The filter medium is constructed in a manner to withstand to a certain extent the load forces in the wellbore. The materials used for the filter medium are preferably somewhat resistant to erosion, corrosion, and high temperatures under most wellbore conditions. The filter medium may be made of ordinary steel fibers, stainless steel fibers, or other metal (e.g. brass) fibers. The best operational life is usually achieved with stainless steel metal fibers.

The filter medium must be permeable to selected fluids such as one or more of steam, stimulation fluids, oil and/or gas, while able to exclude oversized solid matter, such as proppants, sediments, sand or rock particles. Of course, certain undersize solids may be permitted to pass. The filter medium can be selected to exclude particles greater than a selected size, as desired.

The filter medium strip may have dimensions to suit a given application. Typically, the filter medium strip is formed from fibers that may vary from roughly circular to roughly triangular in cross-section and are approximately 20 to 485 μm in thickness (sometimes also referred to as “gauge size”). The filter medium has a weight of approximately 20 to 180 grams per meter (g/m) of filter medium strip length. The filter medium has a filter bed with a thickness of approximately 1/64″ to ⅜″ and a density of approximately 0.1 to 10 g/cm³. The width of the strip of filter medium may range from for example 1″ to 8″ and generally the width of the strip is greater than the thickness of the filter medium. The width of the filter medium strip may be selected based on the outer diameter of the pipe to be wrapped. However, the above-noted dimensions are subject to substantial variation. A common diameter for a storage roll of the filter medium ranges from about 12″ to about 36″ when the roll is full.

Preferably, the filter medium comprises multiple layers of woven steel meshes, wherein each layer is substantially uniform throughout but its weave pattern and/or the average thickness of its fibers may be different from at least one of the other layers in the filter medium. In another embodiment, each layer contains in itself fibers of various thicknesses. In the filter medium, the planes of the layers are substantially parallel to one another. In a further embodiment, the weave of each layer is oriented differently than at least one of the other layers, such that the warp and weft fibers in one layer do not run in the same directions as those in an another layer. In a still further embodiment, the thread tension of the fibers in each layer is different from that of at least one of the other layers. In another embodiment, the fibers in each layer are under a variety of thread tensions. For example, the warp fibers may be under a different tension than the weft fibers in the same layer.

In one embodiment, depending on the weave patterns, the number of layers, thickness of the fibers, and configuration of the woven steel meshes selected for the filter medium, the filter medium may have one surface that has a different texture than the other surface. For example, the filter medium may have one surface that is rougher than the other surface. In a sample embodiment, the rougher surface may be disposed adjacent to the outer surface of the pipe during wrapping. In another embodiment, the smoother surface may be disposed adjacent to the outer surface of the pipe during wrapping.

Weave patterns that may be used in a layer of the filter medium include for example:
plain weave, where each weft wire goes alternatively over and under one warp wire;
basket weave, where two or more wires are used in both the warp and weft directions. These groups of wires are each woven as one thread; and
x/y twill weave, where each weft wire passes under x number of warp wires and over y number of warp wires, and so on, with an offset between rows of wires to create a diagonal pattern in the weave.

The layers of the filter medium may all have the same weave pattern while other characteristics of each layer, as discussed above, may vary from one layer to the next.

The structure of the filter medium thus provides an assortment of pore shapes and pore sizes with a wide statistical distribution around the mean size of the structure. In one embodiment, the structure of the filter medium provides pores that have a special characteristic. Specifically, the pores in the filter medium may be said to be three-dimensional because each of the pores provides a space that is three-dimensional in shape (i.e. having a length, width, and depth). Therefore, all three dimensions are used to describe the shape and size of each pore in the filter medium of the present invention. Preferably, the filter medium has pore sizes, which is measured by each pore's largest dimension (i.e. one of length, width, or depth), ranging from 5 to 750 μm. The variation in pore shapes and sizes assists in maintaining productivity and integrity of the screen during operation, even in a wellbore environment where reservoir particulates are very heterogeneous.

In a preferred embodiment, the filter medium provides a high initial permeability and provides some resistance to clogging and/or plugging for a range of particle sizes. The variation of pore shapes and/or sizes in the filter medium of the present invention may help in increasing the filter medium's resistance to clogging. Permeability is generally a measure of the decrease in pressure in relation to a defined flow volume of air or fluid through a permeable surface. For a filter medium having fibers with gauge sizes ranging from 125 to 485 μm, the initial permeability of the filter medium may range for example from 1310 to 1950 Darcys, or higher in some cases depending on the specific construction of the filter medium. The filter medium may be incorporated into other filter media of different constructions. It can be appreciated that other structures and/or materials that function substantially the same as the aforementioned examples may be used for the filter medium.

In a preferred embodiment, the filter medium of the present invention is configured to have more stretchiness (sometimes also referred to as “sleaziness”) on the bias and/or on the grain than the conventional screens. This may be accomplished by having at least some of the fibers in the filter medium woven under lower tensions, such that these fibers are not straight when the filter medium is in a neutral position (i.e. the filter medium is not under tension or compression on the bias or on the grain or in any direction therebetween). When tensile or compressive force is applied to the filter medium in any given direction, the low tension fibers are straightened out before their strain characteristics take over, thereby allowing the filter medium to be stretchy.

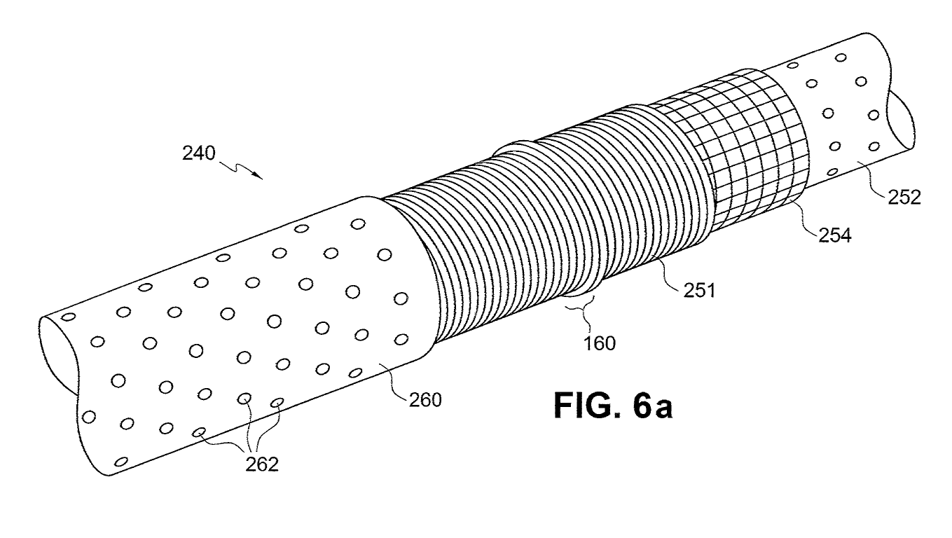

In one embodiment, with reference to FIGS. 2 and 3, the next step is to align the filter medium strip 139 at an acute angle X to the pipe axis, which is also lathe axis 142, at the end of the pipe on to which the filter medium is to be applied. The end of the filter medium strip is then affixed to one end of the aperture portion of pipe 150, by welding, clamping, or other means, such as an end ring. In FIG. 2, this has been done by mounting the strip storage roll 138 on carriage 136 with its axis 140 at the desired angle to position strip 139 to extend away from the pipe at the acute angle X. Lathe 120 is now actuated to rotate pipe 150 as indicated by arrow D, FIGS. 2 to 4. Rotation of pipe 150 pulls the filter medium strip 139 from its storage roll 138 in the direction of arrow E. Strip 139 is maintained under tension while being wrapped helically around apertured section 152. The tension on strip 139 may range from, for example, ten pounds to several thousand pounds (for example 10 lbsf to 5000 lbsf). The tension employed will vary depending on various factors such as the design and metallury of the weave. FIG. 2 shows an intermediate point in the method of wrapping of a layer of the filter medium strip onto the pipe. As strip 139 is wrapped around the base pipe, the lengthwise edges of the strip may connect or overlap to form an interface 160 to avoid an opening between the edges of adjacent wraps, for example as shown in FIG. 5c. Interfaces 160 along the length of the pipe help prevent particles greater than a selected size from passing through the filter medium at the interfaces.

Interfaces 160 may be left untreated or optionally treated to further secure same. There are various ways to treat interfaces 160 including for example by welding, adhesives, fusion, clamping, etc. In another embodiment, throughout the wrapping operation device 144 via rod 145 places the treatment head on or near each interface to treat and secure the interface 160. The interfaces 160 are treated as the interfaces are formed. In an alternative embodiment, the interfaces are treated after the wrapping of the strip is completed. In one embodiment, the treatment head exerts pressure on the interfaces to clamp the overlapping filter medium together. In another embodiment, the treatment head rolls over the interfaces to compress the overlapping filter medium together. Further, the filter material at the interface may be bent to enhance strength or integrity of the interface. In another embodiment, the filter medium has selected fibers woven therein having a lower melting point than the remaining fibers such that interfaces 160 may be bonded by applying heat to the interfaces to fuse the selected fibers together. The heat for bonding the interfaces may be provided by the treatment head.

Further, the treatment of interfaces 160 may include shaping of the lengthwise edges of the filter medium. For example, the lengthwise edges of either side of the strip may be shaped in such a manner that the shapes of the edges of adjacent wraps can mate and/or interlock to form a secured interface. For example, FIGS. 5a and 5b each show a sample embodiment wherein the edges of the strip are shaped to interlock with adjacent wraps. In FIGS. 5a and 5b, one lengthwise side of the strip of filter medium is formed with a groove 24 at or near the edge and the other side of the strip is formed with a protruding lip 26 at or near the edge, such that when the two sides overlap at or near the edge, lip 26 mates with groove 24 to form an interlocking fold that can withstand a certain amount of axial forces to maintain the connection at the interface. Treatment device 144 may be used to apply pressure via the treatment head to the shaped interfaces 160 to further enhance the strength or integrity of same.

The formation of interfaces 160 by overlapping the lengthwise edges of adjacent wraps and/or some of the above-discussed treatments of the interfaces 160 may render welding unnecessary, which may help minimize the cost of and the time for manufacturing and quality control procedures.

The stretchiness of the filter medium allows the filter medium to be pulled and wrapped tightly around the outer surface of pipe 150, and assists in the formation of interfaces 160 at the overlapping edges of the filter medium. The lack of stretchiness in the filter medium can cause the medium to wrap around the pipe in an ice cream cone-like manner along the length of the pipe, such that some of the filter medium is not in physical contact with the outer surface of the pipe.

In one embodiment, a layer of the filter medium strip 139 is wound on to the apertured section 152 of pipe 150 throughout its length L. Throughout this operation, tension is applied to strip 139, which may be achieved by applying some drag on the rotation of the supply roll 138, for example by installing a brake to the supply roll or other means, or by clamping the filter medium strip after it rolls out of the supply roll. As pipe 150 is rotated, strip 139 unwinds from the supply roll against the force created by the brake. Throughout the winding of the filter medium strip onto the pipe 150, carriages 135 and 136 should be moved along paths parallel to the pipe (see arrows F and G) so that a uniform helical winding is effected. That is the purpose of guide rails 133 and 134 and their engagement with carriages 135 and 136, respectively.

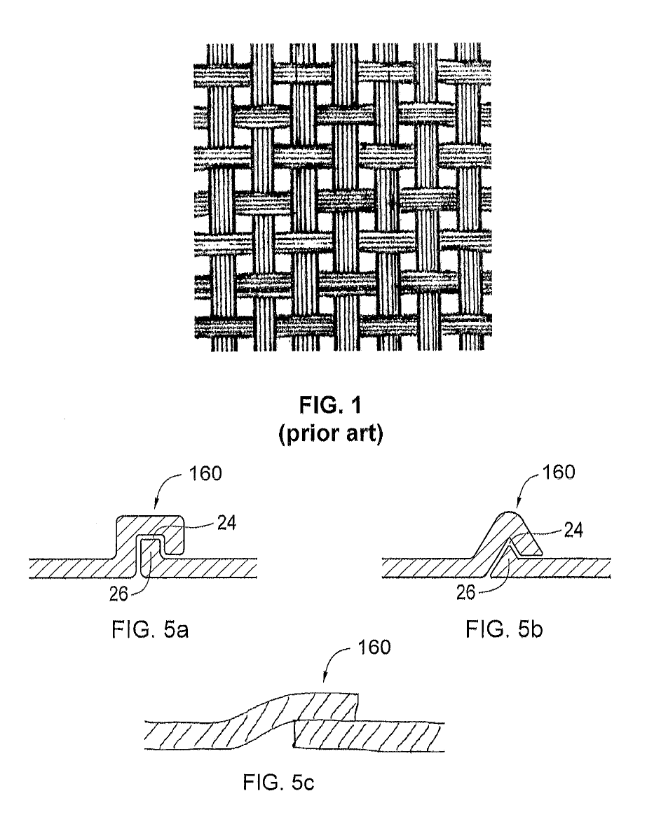

In a further embodiment, when a complete first layer of the filter medium strip 139 has been wound under tension on to the full length L of the apertured pipe section 152, the direction of movement of carriages 135 and 136, which has been from left to right as seen in FIG. 1, is reversed. Thereafter, a second layer of the filter medium is helically wound under tension on to the apertured pipe. When the second layer is complete, the direction of movement of the carriages 135 and 136 is again reversed and a third layer is started. The alternate, back-and-forth carriage movements are repeated, with pipe 150 rotating continuously in lathe 120, until the desired number of helical layers of the filter medium are superimposed upon each other around the perforate section 152 of pipe 150. The tension applied to the strip during wrapping may be varied for each layer. The number of layers used is a matter of meeting the filter requirements for a given application. Because the lathe continues to rotate in the same direction throughout the process, while the carriage 136 moves the strip back and forth, each alternate wrapped layer will be helically wound in a direction opposite to the one applied directly therebelow, such that the layers overlap in a crisscrossing manner.

In another embodiment, each woven mesh layer comprising the filter medium is wrapped separately as its own strip on to pipe 150 using the above-described method and apparatus. As discussed above, the weave pattern, fiber sizes and/or fiber tension of each mesh layer may vary in comparison with another mesh layer in the filter medium. As the mesh layer strip is wound on to the aperture section 152, the tension applied to each mesh layer may be different than that of another separately-wound mesh layer, to create a filter medium that has a plurality of layers of steel mesh.

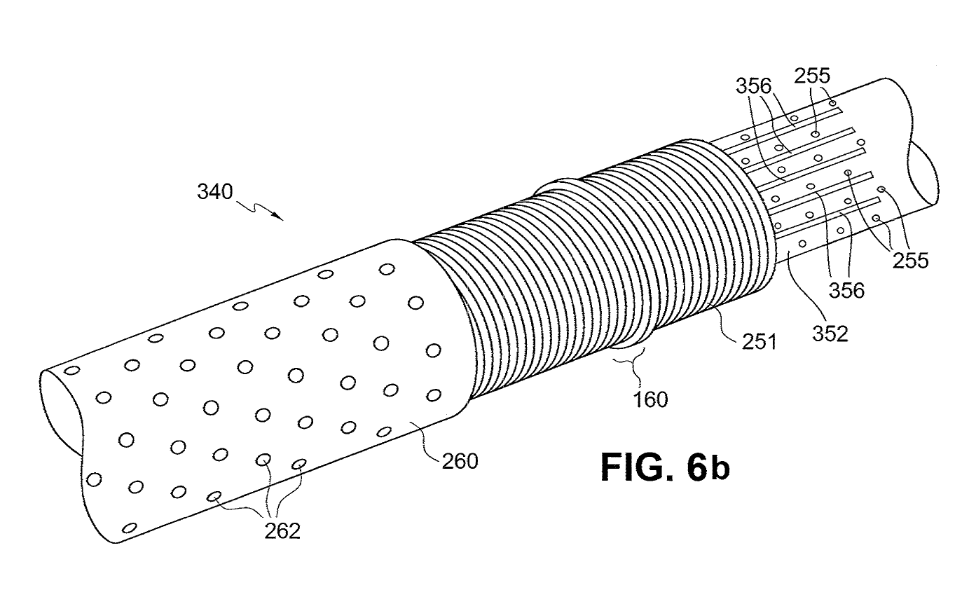

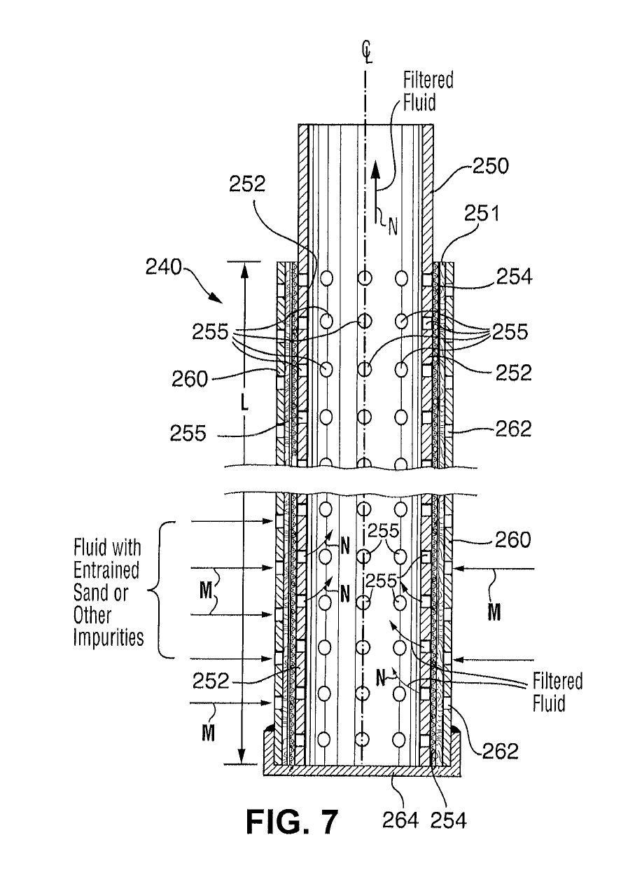

Referring to FIGS. 6a and 7, a wellbore screen 240 includes a section of apertured base pipe 252 having a length L formed as part of or connected to a pipe 250 of the production string. Base pipe 252 is made of materials capable of operating in wellbore conditions, which may include for example metals, ceramics, polymers, etc.

In this illustrated embodiment, there is an optional tubular drainage member 254 around the exterior of the base pipe 252, throughout the length L in which there are perforations 255 extending through the wall. Outwardly from the mesh 254 or from the base pipe 252 (if mesh 254 is omitted) is an intermediate layer including a filter layer 251. In one embodiment, filter layer 251 is a sheet of the above-described filter medium wrapped in a single layer around the apertured base pipe 252. In a further embodiment, more than one sheet of the filter medium may be wrapped around the apertured base pipe to form filter layer 251. In another embodiment, filter layer 251 is formed from a strip of metal filter medium wound helically, under tension, around the apertured pipe 252 in a manner such as that described above. While one layer is shown in FIG. 7; more layers of filter medium may be used, depending on the application in which screen 240 is used. The filter layer 251 filters out sand and other impurities from fluid passing into the interior of the filter's base pipe and out through pipe 250.

A tubular shell 260, having a length L and a plurality of apertures 262, such as perforations, channels, underlays, or slots, fits tightly over the filter layer 251. The shell 260 helps protect the filter layer 251 during deployment of the wellbore screen. A cap 264 may be provided at the end of pipe section 252 opposite the outlet afforded by pipe 250. Apertures 255 and 262 can be positioned to direct flow in selected ways through the wellbore screen. In one embodiment, the plurality of openings 255 of base pipe 252 are offset both axially and radially from any opening 262 of shell 260. In such a configuration, fluid flow into or out of the wellbore screen cannot flow directly radially from openings 255 to openings 262. Instead fluid is forced to have residence time in the intermediate layer between the base pipe 252 and shell 260, wherein fluid is forced to flow axially and/or circumferentially along the intermediate layer to pass between openings 255 and openings 262.

The drainage member 254 between pipe 252 and the filter layer 251 of filter medium serves a purpose in screen 240. If there is no drainage member 254, the fluid may tend, over time, to develop relatively larger passages between at least some of the outer apertures 262, in shell 260, and the inner apertures 255, in pipe 252. That passage enlargement may reduce the effectiveness of screen 240, with the result that less sand and other impurities are filtered out of the fluid traversing the screen. The drainage member may help minimize the decrease in fluid pressure of production fluids flowing from the filter layer to the base pipe. The drainage member may also help increase flow capacity.

Wellbore screen 240 may optionally include a retention layer (not shown) disposed between filter layer 251 and shell 260 to help keep the filter layer in place. The retention layer is made of porous material that may provide further surface drainage and protection for filter layer 251. In one embodiment, the retention layer is wrapped over at least a portion of the outer surface of filter layer 251. The retention layer may be made of various materials including for example a high porosity layer of compressed steel fiber, unstraightened or wavy wire strips, drawn wires, strips of large pore size woven materials, and other materials capable of operation in wellbore conditions. It can be appreciated that other materials that function substantially the same as the aforementioned example may be used for the retention layer.

The various components of the screen 240, including base pipe 252, filter layer 251, shell 260, and optionally drainage member 254 and/or retention layer may be held together in various ways, including for example by welding, fusing, forming, boss ring structures, high pressure crimping, etc. The layers may be connected at their ends and/or by intermediate spacers. In one embodiment, two or more of the layers may be in contact with a substantial portion of the surface of an adjacent layer to provide more structural integrity than a single layer. In a further embodiment, all the layers of screen 240 are in contact with adjacent layers such that there is substantially no space between the layers, thereby minimizing the thickness of the screen (i.e. the distance between the inner surface of base pipe 252 and the outer surface of shell 260) and providing a combined structure that may be more resistant to damage under severe wellbore conditions than a screen having multiple spaced-apart layers.

In operation of screen 240 of FIGS. 6a and 7, the screen is secured in a production string. Other similar screens may be installed along the string. Fluid with sand or other entrained impurities enters apertures 262 in shell 260 as indicated by arrows M. The fluid passes through the layer 251 of filter medium, leaving the entrained sand and other impurities behind. The filtered fluid enters the central, open area in pipe 252 through its apertures 255 and flows out of the filter, as indicated by arrows N. Of course, a pressure differential across the plural layers of screen 240 is necessary for sustained, continuous flow, but that is necessary for virtually any filter. Moreover, the flow is reversible, with the same filter effect.

FIG. 6b illustrates an alternative embodiment of the screen of FIG. 6a. In FIG. 6b, a screen 340 comprises a section of apertured base pipe 352 having a length L formed as part of or connected to a pipe of the production string. Screen 340 includes a filter layer 251 wrapped around the outer surface of base pipe 352 and a tubular shell 260 fitting over filter layer 251 and having apertures 262. Filter layer 251 may include one or more overlapped interfaces 160. The filter layer 251 and tubular shell 260 and their features and method of installation are all as described above with respect to screen 240. In this embodiment, the screen 340 does not include a drainage member.

In the illustrated embodiment of FIG. 6b, base pipe 352 has apertures 255 extending through the wall thereof. Base pipe 352 also has one or more channels 356, which helps create flow paths for directing the flow of fluid therethrough along the outer surface of the base pipe, underneath the filter layer 251, when screen 340 is in use. In one embodiment, the channel 356 is an indentation on the outer surface of the outer housing, including for example a slot and/or groove. In another embodiment, the channel 356 is formed between at least two radially outwardly projecting portions and/or members on the outer surface of the base pipe. For example, the outer surface of the base pipe may include a plurality of ridges that define channels therebetween. The channel 356 may be linear in shape and may be formed to extend lengthwise on the outer surface of the base pipe. In another embodiment, at least a portion of the channel may be curved, C-shaped, S-shaped, etc. Further, the depth of the channel may be substantially uniform or may vary along the length of the channel. In addition to its shape, the length, width, and depth of the channel may vary depending on the characteristics of the fluid to flow therethrough and/or the overall dimensions of the base pipe. The number of channels formed on the outer surface of the base pipe and the spacing between adjacent channels may also vary.

Other features of base pipe 352 are as described above with respect to base pipe 252 of screen 240. Apertures 255 and 262 of screen 340 can be positioned to direct flow in selected ways through the wellbore screen, as described above. Wellbore screen 340 may optionally include a retention layer (not shown) disposed between filter layer 251 and shell 260 to help keep the filter layer in place, as described above.

The various components of the screen 340, including base pipe 352, filter layer 251, shell 260, and optionally the retention layer may be held together in various ways, as described above in relation to screen 240. The operation of screen 340 is the same as that described above with respect to screen 240.

Screens 240, 340 may be used in many types of wells, including for example wells with the following characteristics: long horizontal sections, high temperature, high pressure, tight well trajectories and high dogleg severity, corrosive reservoir conditions, and/or low risk tolerance for future remediation.

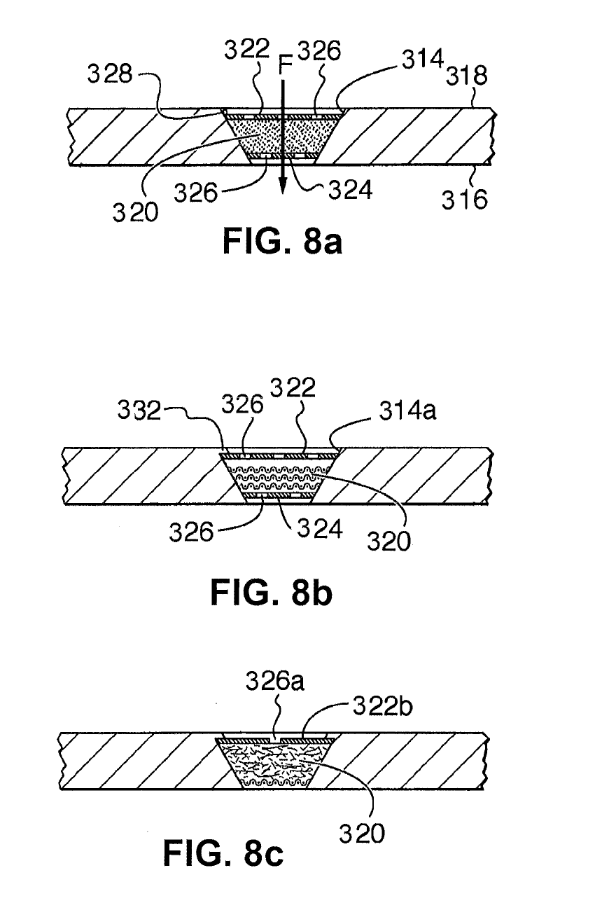

In the embodiment illustrated in FIGS. 6a, 6b, and 7, apertures 255 and 262 are simple unobstructed openings. In a further embodiment, apertures 255 and/or 262 are configured to accommodate filter material therein, such as for example filter cartridges. Referring to FIGS. 8a and 8b, a filter cartridge 320 useful in the wellbore screen can comprise the filter medium, as discussed above, or other filter materials such as compressed fiber, woven media, ceramic and/or sinter disk. In one embodiment, the filter cartridge can also include one or more retainer plates positioned about the filter medium. In one embodiment, the filter cartridge includes an exterior retainer plate 322, an interior retainer plate 324 and the filter medium contained therebetween. In one embodiment, the exterior retainer plate and the interior retainer plate may be coupled to one another by any of a plurality of methods, such as adhesives, welding, screws, bolts, plastic deformation and so on. In another embodiment, the retainer plates are not secured together but held in position by their mounting in the base pipe.

If used, the exterior retainer plate and the interior retainer plate may contain one or more apertures 326 through which fluid may flow. The exterior retainer plate and interior retainer plate may be constructed of any suitable material, such as plastic, aluminum, steel, ceramic, and so on, with consideration as to the conditions in which they must operate.

The filter cartridge may be mounted in the aperture 255, 262 by various methods including welding, soldering, threading, adhesives, friction-fitting, plastic deformation, thermal-expansion-fitting, etc. A seal, such as an o-ring, may be provided between the filter cartridge and the aperture, if desired.

In one embodiment, at least some filter cartridges may be installed by taper lock fit into the openings. In such an embodiment, each of the filter cartridge and the opening into which it is to be installed may be substantially oppositely tapered along their depth so that a taper lock fit can be achieved. For example, the effective diameter of the opening adjacent outer surface 318 may be greater than the effective diameter of the opening adjacent inner bore surface 316 and cartridge inner end effective diameter, as would be measured across plate 324 in the illustrated embodiment, may be less than the effective diameter at the outer end of filter cartridge and greater than the opening effective diameter adjacent inner bore surface 316, so that the filter cartridge may be urged into a taper lock arrangement in the opening. In particular, the outer diameter of the filter cartridge can be tapered to form a frustoconical (as shown), frustopyramidal, etc. shape and this can be fit into the opening, which is reversibly and substantially correspondingly shaped to engage the filter cartridge when it is fit therein. In one embodiment for example, the exterior retainer plate may exceed the diameter of the interior retainer plate of the filter cartridge. Of course, the filter cartridge may be tapered from its inner surface to its outer surface in a configuration that is frustoconical, frustopyramidal, and so on and the openings of the base pipe may be tapered correspondingly so that their diameter adjacent the inner bore surface is greater than that adjacent the side wall outer surface, if desired. However, installation may be facilitated by use of an inwardly directed taper, as this permits the filter cartridges to be installed from the base pipe outer surface and forced inwardly.

FIG. 8b illustrates an embodiment wherein plastic deformation has been used to form a material extension 332 from the base pipe that overlies the outer surface of the filter cartridge to secure the cartridge in opening 314a. It is noted that a filter medium of multiple layered, woven materials is illustrated.

With reference to FIG. 8c, another embodiment is shown wherein the filter cartridge is formed to act as a nozzle, as by providing a nozzle component such as for example aperture 326a in a retainer plate 322b, and includes filter media 320. As such, the filter cartridge can act to provide sand control and can also have the necessary characteristics to act as a nozzle to vaporize, atomize or jet fluid flow to select injection characteristics. Thus, any fluids introduced through the screen can be shaped or treated to improve contact with the reservoir. In another embodiment, the opening may be formed to act as a nozzle and the filter cartridge may be positioned therein.

In the illustrated embodiment in FIGS. 6a, 6b, and 7, the intermediate layer between base pipe 252 and shell 260 includes filter layer 251 comprising filter medium, and apertures 255 and 262 are simple unobstructed openings. In a further embodiment, the intermediate layer includes filter layer 251 and at least some of apertures 255 include filter material, as described above, and apertures 262 are simple openings. In another embodiment, the intermediate layer includes filter layer 251 and at least some of apertures 262 include filter material, and apertures 255 are simple openings. In yet another embodiment, the intermediate layer of screen 240 (or 340) includes filter layer 251 and at least some of apertures 255 and 262 include filter material. In an alternative embodiment, apertures 255 and 262 include filter material, which may include the above-described filter medium, and filter layer 251 is omitted from screen 240 (or 340).

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. For US patent properties, it is noted that no claim element is to be construed under the provisions of 35 USC 112, sixth paragraph, unless the element is expressly recited using the phrase “means for” or “step for”.

I claim:

1. A filter medium comprising at least two layers of woven metal meshes that differ from one another in at least one of: weave pattern, weave direction, fiber size, and fiber tension.

2. The filter medium of claim 1 wherein fibers in the at least two layers of woven metal meshes are roughly circular or roughly triangular in cross-section and are in the range of 20 to 485 μm in thickness.

3. The filter medium of claim 1 having a weight between about 20 and about 180 grams per meter length of the filter medium.

4. The filter medium of claim 1 having a filter bed with a thickness between about 1/64″ and about ⅜″ and a density between about 0.1 and about 10 g/cm³.

5. The filter medium of claim 1 wherein the thicknesses of the fibers in one of the at least two layers of woven metal meshes are not uniform.

6. The filter medium of claim 1 wherein one of the at least two layers of woven metal meshes has an x/y twill weave pattern, wherein x is 1 and y is greater than 2.

7. The filter medium of claim 1 having pore sizes in the range of 5 to 650 μm.

8. The filter medium of claim 1 having an initial permeability between about 1310 and about 1950 Darcys.

9. The filter medium of claim 1 having an initial permeability greater than 1950 Darcys.

10. A wellbore screen comprising:
an apertured base pipe;
an intermediate filtering layer including a filter medium wrapped around the apertured base pipe, the filter medium comprising at least two layers of woven metal meshes, the at least two layers of woven metal meshes differ from one another in at least one of: weave pattern, weave direction, fiber size, and fiber tension; and
an outer apertured shell over the intermediate layer.

11. The wellbore screen of claim 10 wherein fibers in the at least two layers of woven metal meshes are roughly circular or roughly triangular in cross-section and are in the range of 20 to 485 μm in thickness.

12. The wellbore screen of claim 10 wherein the filter medium has a weight between about 20 and about 180 grams per meter length of the filter medium.

13. The wellbore screen of claim 10 wherein the filter medium has a filter bed with a thickness between about 1/64″ and about ⅜″ and a density between about 0.1 and about 10 g/cm³.

14. The wellbore screen of claim 10 wherein the thicknesses of the fibers in one of the at least two layers of woven metal meshes are not uniform.

15. The wellbore screen of claim 10 wherein one of the at least two layers of woven metal meshes has an x/y twill weave pattern, wherein x is 1 and y is greater than 2.

16. The wellbore screen of claim 10 wherein the filter medium has pore sizes in the range of 5 to 650 μm.

17. The wellbore screen of claim 10 wherein the filter medium has an initial permeability between about 1310 and about 1950 Darcys. 18, The wellbore screen of claim 10 wherein the filter medium has an initial permeability greater than 1950 Darcys.

19. The wellbore screen of claim 10 wherein the filter medium is a strip that is wrapped helically about the apertured base pipe.

20. The wellbore screen of claim 19 wherein the strip is between about 1″ and about 8″ in width.

21. The wellbore screen of claim 19 wherein the strip has lengthwise edges, and at least a portion of the lengthwise edges overlap to form an interface.

22. The wellbore screen of claim 21 wherein the interface is bonded by at least one of:
tension, welding, adhesives, fusion, clamping, pressure, and heat.

23. The wellbore screen of claim 21 wherein the lengthwise edges are shaped to mate at the interface.

24. The wellbore screen of claim 21 wherein the base pipe includes channels on its outer surface.

25. A wellbore screen comprising:
an apertured base pipe;
an outer apertured shell over the apertured base pipe; and
filter cartridges comprising a filter medium, the filter cartridges being disposed in at least some of the apertures of one or both of the apertured base pipe and the outer apertured shell, the filter medium comprising at least two layers of woven metal meshes, the at least two layers of woven metal meshes differ from one another in at least one of: weave pattern, weave direction, fiber size, and fiber tension.

26. The wellbore screen of claim 25 wherein fibers in the at least two layers of woven metal meshes are roughly circular or roughly triangular in cross-section and are in the range of 20 to 485 μm in thickness.

27. The wellbore screen of claim 25 wherein the filter medium has a weight between about 20 and about 180 grams per meter length of the filter medium.

28. The wellbore screen of claim 25 wherein the filter medium has a filter bed with a thickness between about 1/64″ and about ⅜″ and a density between about 0.1 and about 10 g/cm³.

29. The wellbore screen of claim 25 wherein the thicknesses of the fibers in one of the at least two layers of woven metal meshes are not uniform.

30. The wellbore screen of claim 25 wherein one of the at least two layers of woven metal meshes has an x/y twill weave pattern, wherein x is 1 and y is greater than 2.

31. The wellbore screen of claim 25 wherein the filter medium has pore sizes in the range of 5 to 650 μm.

32. The wellbore screen of claim 25 wherein the filter medium has an initial permeability between about 1310 and about 1950 Darcys.

33. The wellbore screen of claim 25 wherein the filter medium has an initial permeability greater than 1950 Darcys.

34. A method for producing a wellbore screen, the method comprising:
forming a filter tube by wrapping an intermediate layer, including a filter medium strip, about an apertured base pipe in a helical arrangement under tension, the filter medium strip comprising at least two layers of woven metal meshes, the at least two layers of woven metal meshes differ from one another in at least one of: weave pattern, weave direction, fiber size, and fiber tension;
positioning the filter tube within the long bore of an outer apertured sleeve; and
securing the outer apertured sleeve and the filter tube together.

35. The method of claim 34 wherein wrapping includes securing a starting end of the filter medium strip to the apertured base pipe; rotating the apertured base pipe about its axis; and applying a pulling tension to the filter medium strip to draw the filter medium strip in a helical orientation on to the apertured base pipe.

36. The method of claim 35 wherein the pulling tension is between about 10 lbsf and about 5000 lbsf.

37. The method of claim 35 wherein the filter medium strip is carried on a supply roll and the pulling tension is applied by a brake in the supply roll.

38. The method of claim 35 wherein the filter medium strip is carried on a supply roll and the pulling tension is applied by clamping the filter medium strip after the filter medium strip rolls out of the supply roll.

39. The method of claim 34 wherein fibers in the at least two layers of woven metal meshes are roughly circular or roughly triangular in cross-section and are in the range of 20 to 485 μm in thickness.

40. The method of claim 34 wherein the filter medium strip has a weight between about 20 and about 180 grams per meter length of the filter medium strip.

41. The method of claim 34 wherein the filter medium strip has a filter bed with a thickness between about 1/64″ and about ⅜″ and a density between about 0.1 and about 10 g/cm³.

42. The method of claim 34 wherein the thicknesses of the fibers in one of the at least two layers of woven metal meshes are not uniform.

43. The method of claim 34 wherein one of the at least two layers of woven metal meshes has an x/y twill weave pattern, wherein x is 1 and y is greater than 2.

44. The method of claim 34 wherein the filter medium strip has pore sizes in the range of 5 to 650 μm.

45. The method of claim 34 wherein the filter medium strip has an initial permeability between about 1310 and about 1950 Darcys.

46. The method of claim 34 wherein the filter medium strip has an initial permeability greater than 1950 Darcys.

47. The method of claim 34 wherein the filter medium strip is between about 1″ and about 8″ in width.

48. The method of claim 34 wherein the filter medium has lengthwise edges, and the method further comprising overlapping at least a portion of the lengthwise edges to form an interface.

49. The method of claim 48 further comprising bonding the interface by at least one of: tension, welding, adhesives, fusion, clamping, pressure, and heat.

50. The method of claim 48 wherein the lengthwise edges are shaped to mate at the interface.

51. The method of claim 37 wherein the supply roll rides along an axis parallel to the apertured base pipe.
